(19) United States
(12) Patent Application Publication
(10) Pub. No.: US 2003/0028400 A1
(43) Pub. Date: Feb. 6, 2003

(54) Method for supplying a telemedical healthcare service

(76) Inventors: Tilo Christ, Erlangen (DE); Heinz Prihoda, Heroldsberg (DE); Volker Schmidt, Erlangen (DE); Siegfried Schneider, Erlangen (DE); Hans-Dieter Schull, Weisendorf (DE); Werner Striebel, Schwarzenbruck (DE); Gudrun Zahlmann, Neumarkt (DE)

Correspondence Address: YOUNG & THOMPSON, 745 SOUTH 23RD STREET 2ND FLOOR, ARLINGTON, VA, 22202

(21) Appl. No.: 10/197,530

(22) Filed: Jul. 18, 2002

(30) Foreign Application Priority Data
Jul. 31, 2001 (DE) 101 37 430.5

(51) Int. Cl. G06F 17/60; G06F 7/00; G06F 17/00

(52) U.S. Cl. 705/2; 707/104.1

(57) ABSTRACT

The invention relates to a method for checking whether a contract on a telemedical healthcare service can be effected between a service provider of the telemedical healthcare service and a customer. In the course of the method, a data processing device (4) of an agent undertakes inquiries with a customer in relation to a telemedical healthcare service. Thereupon, the data processing device (4) makes contact with a first database (5), which includes information on service offers from service providers of telemedical healthcare services, and checks whether a substantially corresponding service offer of a service provider can be assigned to the inquiry.

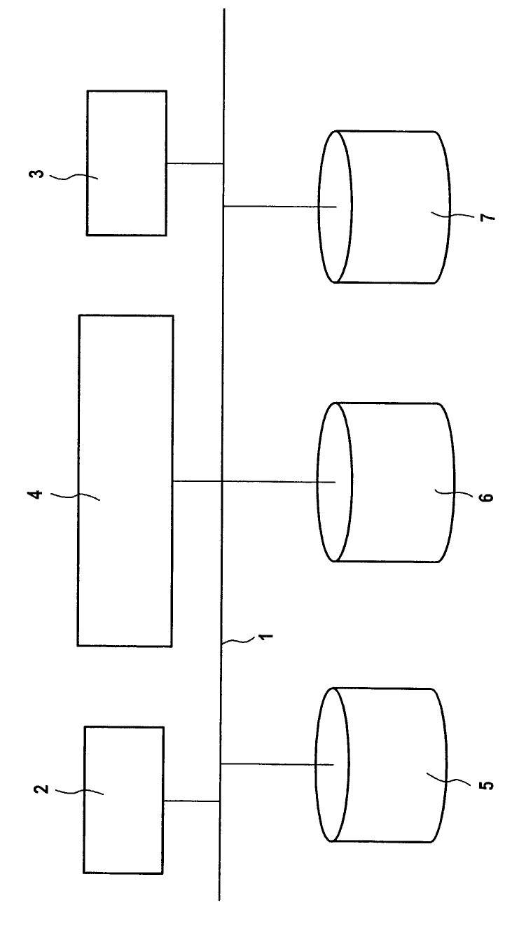

### DESCRIPTION

The invention relates to a method for supplying a telemedical healthcare service between a service provider of a telemedical healthcare service and a customer.

In the procurement of telemedical healthcare services, which are understood to be any types of telemedicine, that is to say, for example, examination of medical data records which are then sent to a service facility for telemedical healthcare services via a communications network, or the online examination of bodily functions using technical means by the remote transmission of data, contracts are effective as a rule between service providers and customers of such healthcare services. However, it is frequently difficult for the needs of the customer to find a suitable service provider as contract partner.

Further problems can arise whenever the customer and the service provider of a telemedical healthcare service are located in different countries, that is to say in different jurisdictions. It is then frequently unclear whether the telemedical healthcare service may even be provided at all in the country of the customer on the basis of legal provisions, and the extent to which such telemedical healthcare services are accepted by the customer's health insurance fund is also unclear. For example, a situation can arise in which a physician working in England is providing telemedical healthcare services in Holland for a patient of Greek nationality visiting there, in the case of which the indicated questions of legal admissibility and the ability to invoice the healthcare service are to be clarified as quickly as possible. This continues to encounter serious problems in practice, since legal conditions required for providing telemedical healthcare services and the boundary conditions for quality may differ from country to country. Mammography screening, which is handled differently in Holland and Germany, may be cited as an example of this.

U.S. Pat. No. 5,835,897 describes a method which is intended to assist managers in public health in being able to determine and compare the quality and the price/performance ratio of service providers in public health. In this case, patients are classified according to their illness and their treatment. The services of different service providers can be compared in relation to the treatment of the illness on the basis of this classification.

It is the object of the invention to specify a method for supplying a telemedical healthcare service in such a way as to simplify checking whether it is possible at all to conclude a contract on the healthcare service between a service provider of a telemedical healthcare service and a customer.

According to the invention, this object is achieved by means of a method for checking whether a contract on a telemedical healthcare service can be effected between a service provider of the telemedical healthcare service and a customer, having the following method steps:

a) acceptance by a data processing device of an inquiry from a customer relating to a telemedical healthcare service,

b) making contact between a first database and the data processing device, which includes information on service offers from service providers of telemedical healthcare services, and

c) checking by the data processing device as to whether the inquiry relating to the telemedical healthcare service can be assigned to a substantially corresponding service offer of a service provider.

The method according to the invention permits an agent of telemedical healthcare services to have recourse in an automated fashion by means of a data processing device to information, stored in a first database, on service offers from different service providers, and to check in an automated fashion whether a service offer exists which can be assigned to the inquiry from a customer. The agent or the agency can thus check in a relatively short time whether a suitable service offer exists, and consequently whether it is possible to conclude a contract covering the healthcare service between a service provider of a telemedical healthcare service and the customer. Given an adequate correspondence between the customer's query and a service offer of a service provider, the customer, the service provider or both parties can be informed so that negotiations can be taken up on the conclusion of a contract for providing the telemedical healthcare service. Medical facilities such as physicians'practices and clinics, or individual physicians can be both service providers for telemedical healthcare services and customers for telemedical healthcare services. The individual patient also comes into consideration as customer.

One embodiment of the invention provides that in the course of the method the data processing device makes contact with a second database, which includes country-specific legal information on telemedical healthcare services. It is possible in this way to clarify which telemedical services are permitted in which countries, and which problems of ethical conduct exist in which countries. It can therefore be established directly and quickly whether the provision of a telemedical healthcare service for a customer is legally permissible in a specific country.

Another embodiment of the invention provides that in the course of the method the data processing device makes contact with a third database, which includes information on which telemedical healthcare services are at least partially paid for by health insurance funds under which conditions, or which are not paid for. The customer therefore learns, in particular, from this inquiry which payments and/or additional payments are possible by his health insurance fund, whether payment splitting, that is to say allocation of the medical provision that can be invoiced to the health insurance fund between two or more service providers, is permissible, and which qualitative basic conditions must be fulfilled for this purpose.

A particularly preferred embodiment of the invention provides that in the case when a customer's query can be assigned a service offer from a service provider, at least an outline contract covering the telemedical healthcare service is produced by the data processing device. The outline contract in the meaning of a draft contract serves as a rule as a basis for the final contract to be concluded between the parties. As the case may be, the outline contract can also be the final contract to the extent that all the contractual conditions are already known and contained in the outline contract.

Variants of the invention provide that the inquiry from a customer includes a medical questioning and identification data of the customer, and that the service offers contained in the first database include the type and the scope of the medical service as well as identification data of the provider. With regard to the medical questioning of the customer, which can comprise a first or second investigation or the monitoring of bodily functions, in particular with regard to the formulation thereof, the customer can be supported by suitable aids, for example by auxiliary questions to be answered by the customer, in order to arrive at an unambiguous, comprehensible and searchable medical questioning. The identification data of the patient preferably include all personal data required to conclude a contract, for example, the name, the date of birth and, if available, the health insurance fund and the health insurance fund number of the customer. The identification data of the service provider include in a corresponding way all data of the service provider that are required to conclude a contract, that is to say, for example, name and address of the service provider, as well as admission to the fund. It is possible in this way to draw up an outline contract between the customer, the agent and the service provider without lengthy communication.

Embodiments of the invention provide that the data processing device interrogates the first database in order to check whether a service provider can meet qualitative and/or quantitative targets included in the inquiry from a customer for the telemedical healthcare service to be provided. This is important, above all, when a relatively large medical facility, for example a special clinic, desires to provide over a specific period of time a telemedical healthcare service of prescribed quality.

A further embodiment of the invention provides that after conclusion of a contract the data processing device produces working instructions and/or guidelines for the customer and the service provider on the basis of the contract content, in order to permit the telemedical healthcare service to be provided smoothly. The production of working instructions and guidelines is particularly simple when the contract corresponds to the outline contract, such that the data processing device need only be informed that the contract has been concluded. Otherwise, the amended contract content must be transferred to the data processing device such that the data processing device can take account of the amended contractual conditions when producing the working instructions and guidelines.

According to a particularly preferred variant of the invention, the method is carried out fully automatically by the data processing device, which has the function of a contract checking module. In accordance with a variant of the invention, the data processing device is designed in this case as an expert system that checks, on the basis of knowledge and while taking account of all legal, accounting and qualitative boundary conditions, whether it is possible to conclude a contract and, if appropriate, draws up at least one outline contract.

One embodiment of the invention provides that the contract checking module is connected to a public communications network, for example the Internet, such that the contract checking module can be reached by virtually anyone.

In accordance with variants of the invention, three databases are also connected to the public communications network. Consequently, the databases need not necessarily be local databases.

An exemplary embodiment of the invention is illustrated in the attached schematic, which shows a communication structure for carrying out the method according to the invention.

In the case of the present exemplary embodiment, the communication structure has a public communications network 1 to which a computer 2, for example a PC, of a customer, a computer 3, for example a PC, of a service provider, a data processing device 4 of an agent for telemedical healthcare services, and three databases 5 to 7 are connected. The communications network 1 is the Internet in the case of the present exemplary embodiment. The data processing device 4 is a contract checking module that is designed as an expert system, that is to say operates in a knowledge-based fashion.

The database 5 is a so-called service database that contains information on telemedical service offers from various service providers. In particular, the database contains information on which type of telemedical healthcare services are provided by the service providers in which number per time unit and at which extent and at which level of quality, that is to say, for example, whether medical specialists are available or in which way the investigation is performed, that is to say which telemedical services are included in a service packet of a service provider. Moreover, the database 5 contains information on required input data for checking an inquiry from a customer, for example on the anamnesis, that is to say the prehistory of an illness, on existing investigations or on available diagnostic image information and the quality thereof.

The database 6 is a legal database that contains country-specific legal information relating to telemedical healthcare services. Stored here is, in particular, information on those countries in which telemedical healthcare services are permitted and may therefore be provided. Moreover, the database 6 contains country-specific information relating to ethical conduct which refers to the provision of medical, in particular telemedical healthcare services.

The database 7 is a so-called accounting database that contains information on which telemedical healthcare services are paid or not paid, at least in part, by which health insurance fund in which country and under which conditions.

In the case of the present exemplary embodiment, the customer or else the patient, who is a German citizen and has his residence, which is also to be the service location, in Germany, is suffering from an already diagnosed illness that requires regular checking of the blood clotting values of the customer with the aid of appropriate medical monitoring of the course of the disease, something which can be performed telemedically. The customer seeking a suitable service provider of a healthcare service that provides these services uses his computer 2, a suitable network browser, for example the Netscape® Communicator 4.5 program from Netscape Communications Corporation and the corresponding Internet address to call up via the Internet 1 the so-called home page of the contract checking module 4 of the agent for telemedical healthcare services, which is taken to mean a start page of a computer program that handles an inquiry from the customer with regard to the telemedical healthcare service he desires.

With the aid of the computer program, and preferably under the guidance of the computer program, on the one hand identification data of the customer are recorded, and on the other hand as long as it has not already been appropriately formulated by the customer, medical questioning is formulated with reference to the monitoring of the blood clotting values, this questioning being specified in such a way that a service offer of a service provider can be searched for in the database 5. In this case, information is also recorded in relation to existing investigations, to the course of the disease, and to service wishes of the customer, for example complete payment of the healthcare service by his health insurance fund and provision of an instrument for automated measurement of the blood clotting values.

If a customer's identification data are present, these being, as a rule, at least the name, the address, the date of birth and, if present, the health insurance fund and the health insurance number of the customer, and if the medical questioning is sufficiently specific, the contract checking module 4 automatically searches in the database for a suitable telemedical healthcare service in the service offer of various service providers. The aim in this case is to seek service offers that at least substantially fulfill the wishes of the customer with regard to the telemedical healthcare service for monitoring the blood clotting values. The service providers of the telemedical healthcare services are located in, or generally offer their healthcare services from different countries.

In the case of the present exemplary embodiment, the computer program of the contract checking module 4 has three suitable service offers, corresponding to the wishes of the customer, from three different service providers. One of the service providers has its registered office in Germany, one in the USA and one in Australia. The computer program of the contract checking module 4 subsequently automatically uses the legal information present in the database 6 to check whether legal problems with regard to the provision of the desired telemedical healthcare service can occur on the basis of the nationality of the customer, the customer's residence and service location, and on the basis of the registered office of the service providers concerned. No such legal problems exist in this case. Consequently, each of the service providers determined with a registered office in Germany, USA or Australia could, from the legal point of view, provide the telemedical healthcare service for the customer.

The computer program of the contract checking module 4 also checks the payment situation of the telemedical healthcare service for monitoring the blood clotting values for the customer with the aid of the information, contained in the database 7, on the means of accounting. In the case of the present exemplary embodiment, should he wish to make use of the service offer of the service provider with registered office in the USA, or of the service offer of the service provider with registered office in Australia, the customer would need to pay for the healthcare service completely himself, since the customer's health insurance fund would not accept the costs for providing this telemedical healthcare service on the part of a service provider in the USA and Australia. Since the customer has wished the costs for the telemedical healthcare service to be paid in full, the computer program of the contract checking module 4 selects the service provider with registered office in Germany. Since the database 5 includes all the data, required for concluding a contract, of the service provider with registered office in Germany, that is to say, on the one hand, the identification data of the service provider, which comprise at least the name, the address and the admission to the fund, and, on the other hand, the type and the scope of the service, that is to say, for example, the provision of an instrument for automatically measuring the blood clotting values, as well as the assurance of the daily checking of the blood clotting values by a medical specialist, and, moreover, the customer data are present, the computer program of the contract checking module 4 can automatically produce an outline contract, that is to say a draft contract, that is directed to the telemedical healthcare service with the customer and the service provider as contract parties.

The draft contract is transferred automatically, for example by email, via the communications network 1 from the contract checking module 4 to the customer's computer 2 and the service provider's computer 3, which can make contact with one another in order to conclude the contract with legal force. As the case may be, the draft contract can, for example, already be the final contract between the customer and the service provider if the two contract parties agree on the content of the draft contract.

However, it is not absolutely necessary for the data processing device 4 to produce an outline contract. Rather, the customer, the service provider or both can also merely be informed by the agent or in an automated fashion by the data processing device 4, for example by email, so that these can contact one another for contract negotiations.

The invention has been explained above with the aid of a telemedical healthcare service for monitoring blood clotting values. However, the invention is not limited to this or similar telemedical healthcare services. Rather, the method according to the invention can be used to check any forms of telemedical healthcare services, be these of diagnostic or therapeutic type, as to whether it is possible to come to the conclusion of a contract for providing a telemedical healthcare service between a customer and a service provider of such a telemedical healthcare service.

Accordingly, the invention also renders it possible for a relatively large medical facility that would like to have provided over a specific period a specific number of telemedical healthcare services per time unit and of a specific quality to find a suitable contract partner for providing the telemedical healthcare services. In accordance with a second exemplary embodiment, a clinic located in the USA and specializing in the treatment of diabetes is seeking an ophthalmic clinic that can examine per week within the next half year two hundred fundus images of diabetic patients for diabetic retinopathies and, in the process, ensures a sensitivity of 98% and a specificity of 89%. The sensitivity and the specificity are in this case criteria with the aid of which the quality of the examination results can be judged. The sensitivity is determined with the aid of known examination results, a check being made as to how many of the known examination results are recognized which conclusively indicates an illness or abnormality. In the case of the specificity, known examination results are used to check how many of the known examination results are detected which conclusively do not indicate an illness or abnormality.

As already described, with the aid of a computer, for example with the aid of the computer 2 shown in the figure, the clinic can direct an appropriate inquiry to the data processing device 4, which uses the targets included in the inquiry to seek a suitable service provider for providing this telemedical healthcare service by being in contact with the database 5. If the computer program or the data processing device 4 has found one or more suitable service providers inside or else outside the USA, in this case, as well, the legal circumstances for the telemedical healthcare service to be provided, and the accounting questions are also clarified in this case by interrogating the databases 6 and 7. In particular, in the case of the present exemplary embodiment a check is made as to whether when commissioning one of the service providers determined the clinic can itself invoice the investigation service directly with the patient's health insurance fund, or whether the clinic can invoice only the taking of the fundus images with the patient's health insurance fund, and the service provider himself must invoice the patient's health insurance fund with the investigation service.

If these questions are clarified in such a way that a contract can be effected between the clinic and a service provider, the computer program of the contract checking module 4 preferably produces an outline contract that is sent to the parties.

Both in the case of the first and in the case of the second exemplary embodiment, it is possible that after a contract has been effected the computer program of the contract checking module automatically uses the contract content as a basis for automatically drawing up for the two parties participating in the respective contract working instructions and guidelines in accordance with which the parties are to proceed in order to provide the telemedical healthcare service smoothly.

The communications network to which the contract checking module and the databases are connected need not, however, necessarily be the Internet. Rather, any other public communications network is also suitable.

Furthermore, the databases 5 to 7 can also be local databases to which only the contract checking module 4 has access. The databases can, moreover, also be combined to form a single database.

1. A method for checking whether a contract on a telemedical healthcare service can be effected between a service provider of the telemedical healthcare service and a customer, having the following method steps:
a) acceptance by a data processing device (4) of an inquiry from a customer relating to a telemedical healthcare service,
b) making contact between a first database (5) and the data processing device (4), which includes information on service offers from service providers of telemedical healthcare services, and
c) checking by the data processing device (4) as to whether the inquiry relating to the telemedical healthcare service can be assigned to a substantially corresponding service offer of a service provider.

2. The method as claimed in claim 1, in which the data processing device (4) makes contact with a second database (6), which includes country-specific legal information on telemedical healthcare services.

3. The method as claimed in claim 1 or 2, in which the data processing device (4) makes contact with a third database (7), which includes information on which telemedical healthcare services are at least partially paid for by health insurance funds under which conditions, or which are not paid for.

4. The method as claimed in one of claims 1 to 3, in which in the case when a contract can be effected between a customer and a service provider, at least an outline contract covering the telemedical healthcare service is produced by the data processing device (4).

5. The method as claimed in one of claims 1 to 4, in which the inquiry includes a medical questioning and identification data of the customer.

6. The method as claimed in one of claims 1 to 5, in which the service offer includes the type and the scope of the medical service as well as identification data of the provider.

7. The method as claimed in one of claims 1 to 6, in which the data processing device (4) interrogates the first database (5) in order to check whether a service provider can meet qualitative targets of a customer for the telemedical healthcare service to be provided.

8. The method as claimed in one of claims 1 to 7, in which the data processing device (4) interrogates the first database (5) in order to check whether a service provider can meet quantitative targets of a customer for the telemedical healthcare service to be provided.

9. The method as claimed in claims 1 to 8, in which after conclusion of a contract the data processing device (4) produces working instructions and/or guidelines for the customer and the service provider on the basis of the contract content.

10. The method as claimed in one of claims 1 to 9, which is carried out automatically by the data processing device (4).

11. The method as claimed in one of claims 1 to 10, in which the data processing device (4) is an expert system.

12. The method as claimed in one of claims 1 to 11, in which the data processing device (4) is a public communications network (1).

13. The method as claimed in one of claims 1 to 12, in which the first database (5) is connected to a public communications network (1).

14. The method as claimed in one of claims 2 to 13, in which the second database (6) is connected to a public communications network (1).

15. The method as claimed in one of claims 3 to 14, in which the third database (7) is connected to a public communications network (1).
